(19) United States
(12) Patent Application Publication
(10) Pub. No.: US 2026/0347212 A1
(43) Pub. Date: Nov. 5, 2026

(54) METHOD FOR SYNTHESIZING MULTI-ELEMENT METAL OXIDE NANOPARTICLES

(71) Applicant: Toyota Motor Engineering & Manufacturing North America, Inc., Plano, TX (US)

(72) Inventors: Li Qin Zhou, Okemos, MI (US); Siwen Wang, Livonia, MI (US); Chen Ling, Troy, MI (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 19/196,842

(22) Filed: May 2, 2025

(51) Int. Cl. C01G 55/00

(52) U.S. Cl. CPC C01G 55/004; C01P 2002/72; C01P 2004/04; C01P 2004/64

(57) ABSTRACT

Disclosed is a method for synthesizing single phase multi-element metal oxide nanoparticles. The method involves dissolving an organometallic compound precursor of formula M(acac)ₙ for each different element of the multi-element metal oxide in an organic solvent; impregnating a support with the organometallic compound precursors; reducing the organometallic compound precursors to obtain alloy nanoparticles on the support; and annealing the alloy nanoparticles and the support to remove the support and to convert the alloy nanoparticles to oxide nanoparticles. In the formula M(acac)ₙ, M is one or more of a metal including but not limited to ruthenium (Ru), Iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn), and cerium (Ce); and n is an integer representing the number of acac ligands bound to the respective metal.

### TECHNICAL FIELD

The present disclosure generally relates to methods for synthesizing multi-element metal oxide nanoparticles, more particularly single phase multi-element ruthenium oxides.

### BACKGROUND

Multi-element high-entropy catalysts have been known for their potential to improve catalytic performance. Ru and/or Ir based high-entropy oxide catalysts for oxygen evolution reaction (OER) have attracted ever-increasing attention due to their unique physicochemical properties. Multiple atoms occupying the equivalent lattice sites can generate lattice distortions and regulate the metal oxygen covalencies. Moreover, the configurational entropy induced from mixing multiple elements provides an additional contribution to the structure stability. However, synthesis of monophasic multi-element or high-entropy oxide nanoparticles remains a challenge because it involves various metallic elements that tend to form secondary phase(s) during the process. Traditional liquid phase synthesis including sol-gel and co-precipitation is the most commonly used method to prepare nanoparticles. This method involves dissolving soluble metal salts in a solution with appropriate ratios, resulting in an even distribution of the elements in molecular or ionic states. By dehydrating, precipitating, or crystallizing the metal ions through subsequent processes such as solvent evaporation or pH adjustment, desired powders can be obtained through heating and calcination. However, heating/calcination can result in the agglomeration and aggregation, forming large particles. A water-based wet-impregnation method has been reported for synthesizing Ru/IrO₂ nanoparticles doped with transition metals selected from nickel, iron, cobalt, lanthanum, manganese, copper, zinc, and chromium to produce particles having an average particle size of about 5 nm. However, this method has limitations: some metals do not have water-soluble precursors, i.e., titanium; and secondary phase(s) occur, necessitating an additional leaching step of intermediate mixed oxides to remove the secondary phases, unstable dopants and to obtain the desired catalyst. There is a need for more efficient, effective processes for synthesizing monophasic, multi-element or high entropy metal oxide nanoparticles.

### SUMMARY

This section provides a general summary of the disclosure and is not a comprehensive disclosure of its full scope or all of its features.

In various aspects, the present teachings provide a method for synthesizing single phase multi-element metal oxide nanoparticles, said method comprising: dissolving an organometallic compound precursor of formula M(acac)ₙ for each different element of the multi-element metal oxide, in an organic solvent; impregnating a support with the organometallic compound precursors; reducing the organometallic compound precursors to obtain alloy nanoparticles on the support; and annealing the alloy nanoparticles and the support to remove the support and to convert the alloy nanoparticles to oxide nanoparticles. The single phase is a tetragonal rutile phase. In the formula M(acac)ₙ, M may be one or more metals including but not limited to ruthenium (Ru), Iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn) and cerium (Ce); and n is an integer representing the number of acac ligands bound to the respective metal. In some examples, M may be a metal selected from ruthenium (Ru), cobalt (Co), nickel (Ni), manganese (Mn), chromium (Cr), and titanium (Ti). In some examples, n is an integer between 2 to 4. The multi-element metal oxide nanoparticles may comprise a total of five (5) different metal elements.

In some examples, the organic solvent may be selected from isopropanol and ethanol. The support may be a carbon support selected from carbon black, ketjenblack, carbon nanotubes (CNTs), graphene, carbon nanofibers, and mesoporous carbon. In some examples, impregnating a support with the organometallic compound precursors may comprise wet impregnation. Reducing the organometallic precursors may comprise annealing the organometallic compound precursors at 600-900 °C for 1-5 hours in Ar/7% H₂.

In some aspects, the present teachings provide a method for synthesizing single phase multi-element doped ruthenium dioxide nanoparticles. The single phase is a tetragonal rutile phase. The method comprises: (1) dissolving organometallic compound precursors of formula M(acac)ₙ for each different element of the multi-element doped ruthenium dioxide in an organic solvent; (2) impregnating the organometallic compound precursors on a support; (3) reducing the organometallic precursors to obtain alloy nanoparticles on the support; and (4) annealing the alloy nanoparticles and the support to remove the support and to convert the alloy nanoparticles to oxide nanoparticles. In the formula M(acac)ₙ, M may be one or more metals including but not limited to ruthenium (Ru), Iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn) and cerium (Ce); and n is an integer representing the number of acac ligands bound to the respective metal. In some examples, M may be a metal selected from ruthenium (Ru), cobalt (Co), nickel (Ni), manganese (Mn), chromium (Cr), and titanium (Ti). In some examples, n is an integer between 2 to 4.

The multi-element metal oxide nanoparticles may comprise a total of five (5) different metal elements. In some examples, the ruthenium dioxide nanoparticles comprise Ru_{0.75}(MnNiTiCo)_{0.25}O₂. In other examples, the ruthenium dioxide nanoparticles comprise Ru_{0.75}(CrNiMnCo)_{0.25}O₂.

In another aspect, the present teachings provide a method for synthesizing quaternary-doped ruthenium dioxide of formula Ruₓ(M1M2M3M4)₁₋ₓO₂, said method comprising: (1) dissolving organometallic compound precursors of each of Ru(acac)₃, M1(acac)ₙ, M2(acac)ₙ, M3(acac)ₙ and M4(acac)ₙ in an organic solvent; (2) impregnating the organometallic compound precursors on a support; (3) reducing the organometallic compound precursors to obtain alloy nanoparticles on the support; and (4) annealing the alloy nanoparticles and the support to remove the support and to convert the alloy nanoparticles to oxide nanoparticles. In the formula M(acac)ₙ, M may be one or more metals including but not limited to ruthenium (Ru), Iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn), and cerium (Ce); and n is an integer representing the number of acac ligands bound to the respective metal. In some examples, M may be a metal selected from ruthenium (Ru), cobalt (Co), nickel (Ni), manganese (Mn), chromium (Cr), and titanium (Ti). In some examples, n is an integer between 2 to 4. Reducing the organometallic compound precursors may comprise annealing the organometallic compound precursors at 600-900 °C for 1-5 hours in Ar/7% H₂.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present teachings will become more fully understood from the detailed description and the accompanying drawings wherein:

FIG. 1 provides the X-ray diffraction pattern of synthesized Ru_{0.75}(MnNiTiCo)_{0.25}O₂ along with the peaks from RuO₂ standard (PDF #04-009-8495) provided for comparison.

FIG. 2. is a bright field scanning transmission electron microscopy (STEM) image showing the crystallite structure of synthesized Ru_{0.75}(MnNiTiCo)_{0.25}O₂ (scale bar 5 nm).

FIG. 3A is a high angle annular dark field (HAADF) scanning transmission electron microscopy (STEM) image of nanoparticles of a quaternary doped ruthenium dioxide catalyst material doped with manganese (Mn), nickel (Ni), titanium (Ti), and cobalt (Co) as the dopants for energy-dispersive X-ray spectroscopy (EDS) (scale bar 10 nm).

FIG. 3B is a scanning transmission electron microscopy (STEM) energy dispersive X-ray spectroscopy (EDS) elemental mapping image showing a uniform spatial distribution of oxygen (O) in nanoparticles of the quaternary-doped ruthenium dioxide catalyst material doped with manganese (Mn), nickel (Ni), titanium (Ti), and cobalt (Co) as the dopants (scale bar 10 nm).

FIG. 3C is a scanning transmission electron microscopy (STEM) energy dispersive X-ray spectroscopy (EDS) elemental mapping image showing a uniform spatial distribution of ruthenium (Ru) in nanoparticles of the quaternary-doped ruthenium dioxide catalyst material doped with manganese (Mn), nickel (Ni), titanium (Ti), and cobalt (Co) as the dopants (scale bar 10 nm).

FIG. 3D is a scanning transmission electron microscopy (STEM) energy dispersive X-ray spectroscopy (EDS) elemental mapping image showing a uniform spatial distribution of manganese (Mn) in nanoparticles of the quaternary-doped ruthenium dioxide catalyst material doped with manganese (Mn), nickel (Ni), titanium (Ti), and cobalt (Co) as the dopants (scale bar 10 nm).

FIG. 3E is a scanning transmission electron microscopy (STEM) energy dispersive X-ray spectroscopy (EDS) elemental mapping image showing a uniform spatial distribution of nickel (Ni) in nanoparticles of the quaternary-doped ruthenium dioxide catalyst material doped with manganese (Mn), nickel (Ni), titanium (Ti), and cobalt (Co) as the dopants (scale bar 10 nm).

FIG. 3F is a scanning transmission electron microscopy (STEM) energy dispersive X-ray spectroscopy (EDS) elemental mapping image showing a uniform spatial distribution of titanium (Ti) in nanoparticles of the quaternary-doped ruthenium dioxide catalyst material doped with manganese (Mn), nickel (Ni), titanium (Ti), and cobalt (Co) as the dopants (scale bar 10 nm).

FIG. 3G is a scanning transmission electron microscopy (STEM) energy dispersive X-ray spectroscopy (EDS) elemental mapping image showing a uniform spatial distribution of cobalt (Co) in nanoparticles of the quaternary-doped ruthenium dioxide catalyst material doped with manganese (Mn), nickel (Ni), titanium (Ti), and cobalt (Co) as the dopants (scale bar 10 nm).

FIG. 4 provides the X-ray diffraction pattern of synthesized Ru_{0.75}(CrNiMnCo)_{0.25}O₂ along with the peaks from RuO₂ standard (PDF #04-009-8495) provided for comparison.

FIG. 5 is a bright field scanning transmission electron microscopy (STEM) image showing the crystallite structure of synthesized Ru_{0.75}(CrNiMnCo)_{0.25}O₂ (scale bar 5 nm).

FIG. 6A is a high angle annular dark field (HAADF) scanning transmission electron microscopy (STEM) image of nanoparticles of a quaternary doped ruthenium dioxide catalyst material doped with chromium (Cr), nickel (Ni), manganese (Mn), and cobalt (Co) as the dopants for energy-dispersive X-ray spectroscopy (EDS) (scale bar 20 nm).

FIG. 6B is a scanning transmission electron microscopy (STEM) energy dispersive X-ray spectroscopy (EDS) elemental mapping image showing a uniform spatial distribution of oxygen (O) in nanoparticles of the quaternary-doped ruthenium dioxide catalyst material doped with chromium (Cr), nickel (Ni), manganese (Mn), and cobalt (Co) as the dopants (scale bar 20 nm).

FIG. 6C is a scanning transmission electron microscopy (STEM) energy dispersive X-ray spectroscopy (EDS) elemental mapping image showing a uniform spatial distribution of ruthenium (Ru) in nanoparticles of the quaternary-doped ruthenium dioxide catalyst material doped with chromium (Cr), nickel (Ni), manganese (Mn), and cobalt (Co) as the dopants (scale bar 20 nm).

FIG. 6D is a scanning transmission electron microscopy (STEM) energy dispersive X-ray spectroscopy (EDS) elemental mapping image showing a uniform spatial distribution of chromium (Cr) in nanoparticles of the quaternary-doped ruthenium dioxide catalyst material doped with chromium (Cr), nickel (Ni), manganese (Mn), and cobalt (Co) as the dopants (scale bar 20 nm).

FIG. 6E is a scanning transmission electron microscopy (STEM) energy dispersive X-ray spectroscopy (EDS) elemental mapping image showing a uniform spatial distribution of nickel (Ni) in nanoparticles of the quaternary-doped ruthenium dioxide catalyst material doped with chromium (Cr), nickel (Ni), manganese (Mn), and cobalt (Co) as the dopants (scale bar 20 nm).

FIG. 6F is a scanning transmission electron microscopy (STEM) energy dispersive X-ray spectroscopy (EDS) elemental mapping image showing a uniform spatial distribution of manganese (Mn) in nanoparticles of the quaternary-doped ruthenium dioxide catalyst material doped with chromium (Cr), nickel (Ni), manganese (Mn), and cobalt (Co) as the dopants (scale bar 20 nm).

FIG. 6G is a scanning transmission electron microscopy (STEM) energy dispersive X-ray spectroscopy (EDS) elemental mapping image showing a uniform spatial distribution of cobalt (Co) in nanoparticles of the quaternary-doped ruthenium dioxide catalyst material doped with chromium (Cr), nickel (Ni), manganese (Mn), and cobalt (Co) as the dopants (scale bar 20 nm).

It should be noted that the figures set forth herein are intended to exemplify the general characteristics of the methods, algorithms, and devices among those of the present technology, for the purpose of the description of certain aspects. These figures may not precisely reflect the characteristics of any given aspect and are not necessarily intended to define or limit specific embodiments within the scope of this technology. Further, certain aspects may incorporate features from a combination of figures.

### DETAILED DESCRIPTION

The present disclosure provides a method for synthesizing multi-element metal oxide nanoparticles. In particular, the present disclosure provides a method for synthesizing RuO₂ crystal structures having excellent stability in acidic conditions, employing multi-element lattice doping to stabilize the RuO₂ crystal structure thereby improving its stability. The term “multi-element” may be used interchangeably with multi-component and refers to multiple elements, such as multiple metal cations, incorporated into a single crystalline oxide lattice structure. In some examples of the present disclosure, the multi-element or multi-component metal oxide nanoparticles may be high-entropy metal oxide nanoparticles. “High-entropy” is used in the present disclosure to refer to materials that contain five (5) or more principal elements in equal atomic or nearly equal atomic ratios. In some respects, the present disclosure relates to high-entropy ruthenium oxides which incorporate at least four (4) different metal cations into a single, stable crystalline oxide lattice of ruthenium.

Commonly used methods to prepare nanoparticles include liquid phase synthesis such as sol-gel and co-precipitation. These methods involve dissolving soluble metal salts in a solution with appropriate ratios, often resulting in an even distribution of the elements in molecular or ionic states. By dehydrating, precipitating, or crystallizing the metal ions through subsequent processes such as solvent evaporation or pH adjustment, desired powders can be obtained through heating and calcination. However, heating/calcination, may result in the particle agglomeration and aggregation, forming large particles.

A water-based wet-impregnation method for synthesizing Ru/IrO₂ nanoparticles doped with transition metal selected from nickel, iron, cobalt, lanthanum, manganese, copper, zinc, and chromium has been reported in the literature to produce particles having an average particle size of about 5 nm. The method comprises the following steps. (1) dissolving metal salts precursors in 1M HCl; (2) impregnating precursors on a support (carbon); (3) reducing precursors to obtain alloy nanoparticles on the support; (4) annealing the alloy nanoparticles and the support to remove the support and to convert the alloy nanoparticles to an intermediate mixed oxide; and (5) leaching the intermediate mixed oxide to remove unstable dopant and obtain the catalyst. This method has limitations: some metals do not have water-soluble precursors, i.e., titanium; and secondary phase(s) occur, necessitating an additional leaching step to remove the secondary phases, unstable dopants.

The methods of the present disclosure can be used to synthesize single phase metal oxides, which do not require leaching. The term “single phase” refers to monophasic or pure phase wherein a crystalline material is composed of one single crystallographic phase, without any mixture of other phases, or impurities. In the case of synthesizing multi-element ruthenium-based metal oxides, the single phase is a tetragonal rutile phase, wherein the metal cation sites are occupied by a uniform distribution of different metal elements forming a single-phase solid solution. Oxygen anions (O) are coordinated around the metal centers, forming distorted octahedral units typical of a rutile structure. A leaching step to remove undesired secondary phases is not required in the method of the present disclosure.

The method of the present disclosure comprises: dissolving an organometallic compound precursor of formula M(acac)ₙ for each different element of the multi-element metal oxide, in an organic solvent; impregnating a support with the organometallic compound precursors; reducing the organometallic compound precursors to obtain alloy nanoparticles on the support; and annealing the alloy nanoparticles and the support to remove the support and to convert the alloy nanoparticles to oxide nanoparticles.

Organometallic compounds are chemical compounds that contain at least one bond between a metal atom and a carbon atom of an organic ligand. In the present disclosure, organometallic compounds serve as precursors, meaning they are starting materials that undergo thermal or chemical decomposition to form metal oxides. In the present disclosure, the organometallic precursor compound is a metal acetylacetonate having the formula M(acac)n, wherein M is one or more of a metal including but not limited to ruthenium (Ru), Iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn), and cerium (Ce); acac represents acetylacetonate, a bidentate ligand, used in the preparation of precursor solutions for catalysts nanoparticles; and n is an integer representing the number of acac ligands bound to the respective metal. In some examples of the present disclosure, M is one or more of a metal selected from ruthenium (Ru), cobalt (Co), nickel (Ni), manganese (Mn), chromium (Cr), and titanium (Ti), and n is an integer between 2 to 4.

In some examples of the present disclosure, the organometallic compound precursors are added to an organic solvent and mixed to form a homogeneous precursor solution containing all of the metals to be incorporated into the multi-element metal oxide compound. M(acac)ₙ compounds are generally more soluble in organic solvents (e.g., ethanol, isopropanol, acetone) than in water. Dissolving them allows for the formation of a homogeneous solution, enabling uniform distribution of metal precursors across the support material during impregnation. Suitable organic solvents may include, but are not limited to, ethanol, isopropanol, acetone, toluene, xylene, methanol, tetrahydrofuran, N,N-dimethylformamide, dimethyl sulfoxide, and butanol. In some examples of the present disclosure, the organic solvent may be isopropanol or ethanol.

The organometallic compound precursor solution is then impregnated onto the support material by wet impregnation. Support materials are added to the precursor solution, followed by sonication and stirring for impregnation.

In some examples of the present disclosure, the support is carbon.

After impregnating the support with the organometallic precursor solution, the impregnated support material is exposed to a reducing atmosphere such as hydrogen gas or a hydrogen-containing gas mixture and annealing at a temperature in the range of 600 °C to 900 °C for a period of 1 to 5 hours, to convert the metal precursors into their metallic and form allot nanoparticles on the support. In some examples of the present specification, impregnated support material is annealed in a flowing Ar/H₂ (7%/H₂) atmosphere at 800 °C for 4 hours. The resulting alloy nanoparticles and support are then annealed under oxidizing conditions to convert the alloy nanoparticles to multi-element metal oxide nanoparticles and to remove the support. In some examples of the present disclosure, the alloy nanoparticles and support are annealed in air at 550 °C for 4 hours.

In some examples of the present disclosure, the method of the present disclosure is employed to synthesize high entropy multi-element ruthenium dioxide nanoparticles, which comprise a total of five (5) different metal elements. The synthesized ruthenium dioxide nanoparticles have a pure phase tetragonal rutile-type structure. In other examples, the method of the present disclosure is employed to synthesize quaternary-doped ruthenium dioxide of formula Ruₓ(M1M2M3M4)₁₋ₓO₂ wherein M1, M2, M3, and M4 are each selected from chromium (Cr), Nickel (Ni), titanium (Ti), colbalt (Co), and manganese (Mn).

The nanoparticles synthesized by the method of the present disclosure have an average particle size of less than 10 nm, less than 5 nm, or the range of 2-10 nm, or 3-5 nm.

### EXAMPLES

Various aspects of the present disclosure are further illustrated with respect to the following examples. It is to be understood that these examples are provided to illustrate specific embodiments of the present disclosure and should not be construed as limiting the scope of the present disclosure in or to any particular aspect.

### Example 1. Synthesis of Ru_{0.75}(MnNiTiCo)_{0.25}O₂ Nanoparticles

333.55 mg of Ru(acac)₃, 17.66 mg of Mn(acac)₂, 17.93 mg of Ni(acac)₂, 10.8 μl of Titanium diisopropoxide bis(acetylacetonate) 75 wt. % in isopropanol, and 24.86 mg of Co(acac)₃ were added in 150 ml of isopropanol and sonicated for 2 hours.

0.4 g of carbon black was then added and dispersed by stirring for 20 hours under room temperature. The mixture was dried by using a rotary evaporator and the remaining powder was collected.

The powder was annealed in a flowing Ar/H₂ (7% H₂) atmosphere at 800 °C for 4 hours, followed by annealing in air at 550 °C for 4 hours.

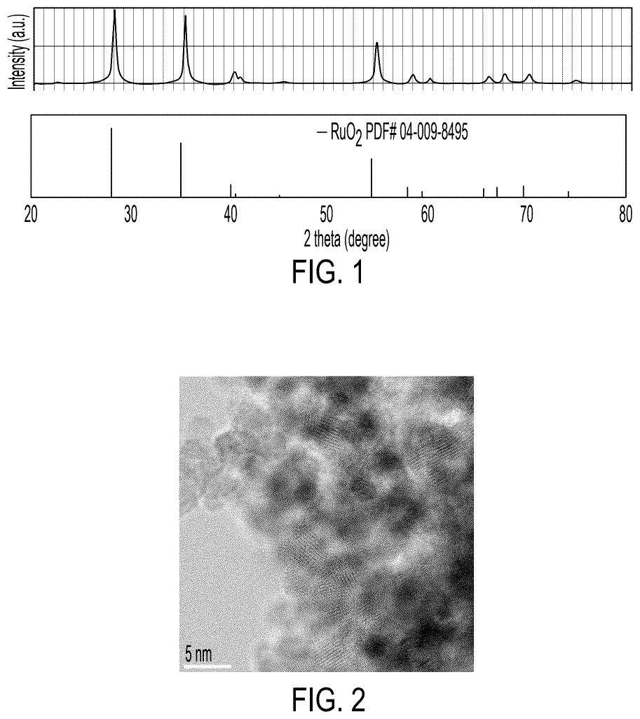

FIG. 1 demonstrates that a pure phase of tetragonal rutile-type structure was achieved in the synthesized Ru_{0.75}(MnNiTiCo)_{0.25}O₂ nanoparticles. The X-ray diffraction (XRD) peaks of synthesized Ru_{0.75}(MnNiTiCo)_{0.25}O₂ shifted to higher 2θ (2 theta) values compared to those of RuO₂, indicating the incorporation of Mn, Ni, Ti, and Co into the RuO₂ crystal lattice. For comparison, peaks from the RuO₂ standard (PDF #04-009-8495) are provided in FIG. 1.

The scanning transmission electron microscope (STEM) image in FIG. 2 displayed a crystallite structure with particle sizes less than 5 nm and good crystallinity in the synthesized Ru_{0.75}(MnNiTiCo)_{0.25}O₂ nanoparticles.

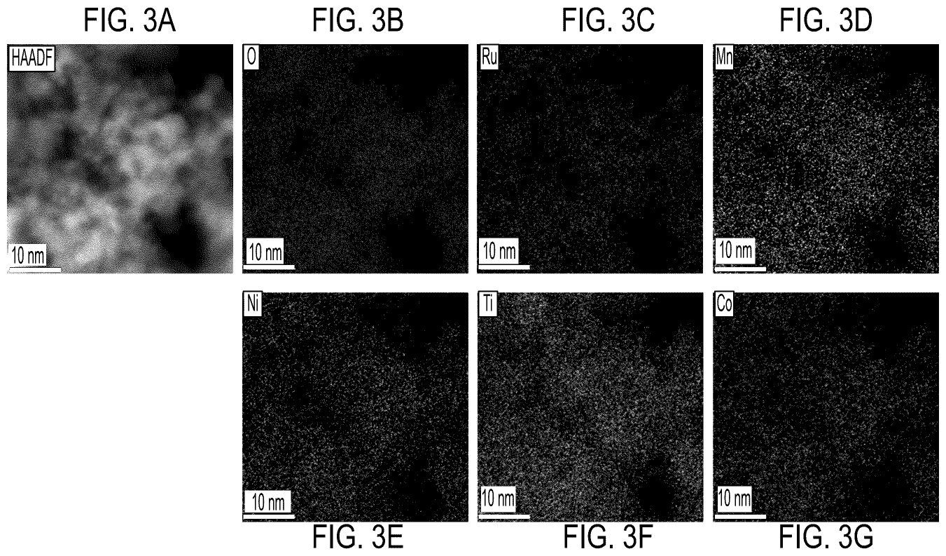

Chemical mapping using energy dispersive X-ray spectroscopy (EDS) in STEM images presented in FIGS. 3A, 3B, 3C, 3D, 3E, 3F, and 3G shows a uniform distribution of Ru, Mn, Ni, Ti, and Co within the nanoparticles, further confirming the lattice doping of Mn, Ni, Ti, and Co.

### Example 2. Synthesis of Ru_{0.75}(CrNiMnCo)_{0.25}O₂

332.59 mg of Ru(acac)₃, 24.30 mg of Cr(acac)₃, 17.87 mg of Ni(acac)₂, 17.61 mg of Mn(acac)₂, and 24.79 mg of Co(acac)₃ were added in 150 ml of isopropanol and sonicated for 2 hours.

0.4 g of carbon black was then added and dispersed by stirring for 20 hours under room temperature. The mixture was dried by using a rotary evaporator and the remaining powder was collected.

The powder was annealed in a flowing Ar/H₂ (7% H₂) atmosphere at 800 °C for 4 hours, followed by annealing in air at 550 °C for 4 hours.

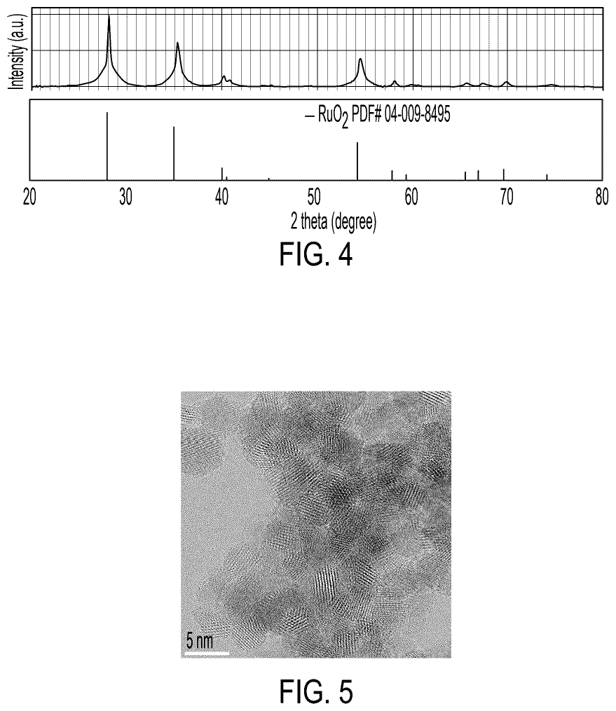

FIG. 4 demonstrates that a pure phase of tetragonal rutile-type structure was achieved in the synthesized Ru_{0.75}(CrNiMnCo)_{0.25}O₂ nanoparticles. The X-ray diffraction (XRD) peaks of synthesized Ru_{0.75}(CrNiMnCo)_{0.25}O₂ shifted to higher 2 θ (2 theta) values compared to those of RuO₂, indicating the incorporation of Cr, Ni, Mn, and Co into the RuO₂ crystal lattice. For comparison, peaks from the RuO₂ standard (PDF #04-009-8495) are provided in FIG. 4.

The scanning transmission electron microscope (STEM) image in FIG. 5 displayed a crystallite structure with particle sizes less than 5 nm and good crystallinity in the synthesized Ru_{0.75}(CrNiMnCo)_{0.25}O₂ nanoparticles.

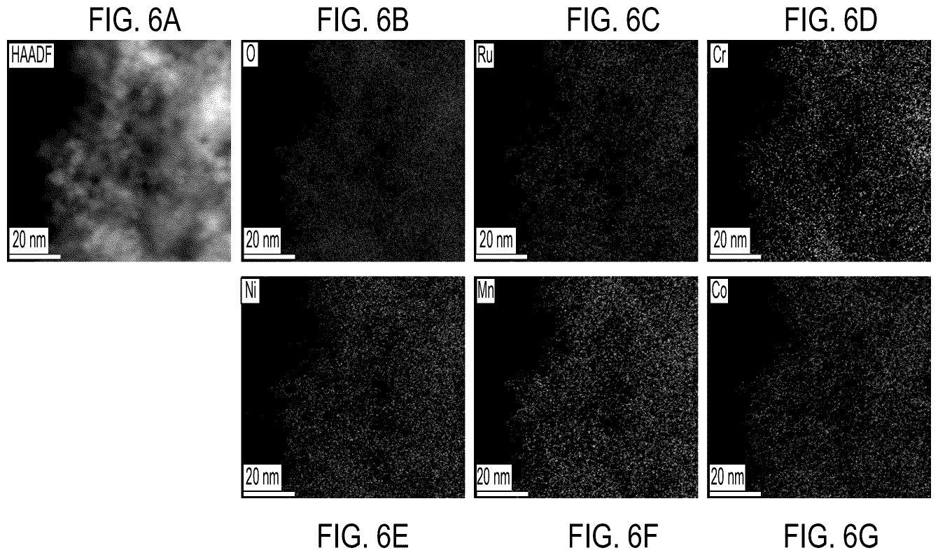

Chemical mapping using energy dispersive X-ray spectroscopy (EDS) in STEM images presented in FIGS. 6A, 6B, 6C, 6D, 6E, 6F, and 6G shows a uniform distribution of Ru, Cr, Ni, Mn, and Co within the nanoparticles, further confirming the lattice doping of Cr, Ni, Mn, and Co.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple embodiments having stated features is not intended to exclude other embodiments having additional features, or other embodiments incorporating different combinations of the stated features.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that an embodiment can or may comprise certain elements or features does not exclude other embodiments of the present technology that do not contain those elements or features.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with an embodiment or particular system is included in at least one embodiment or aspect. The appearances of the phrase “in one aspect” (or variations thereof) are not necessarily referring to the same aspect or embodiment. It should be also understood that the various method steps discussed herein do not have to be carried out in the same order as depicted, and not every method step is required in each aspect or embodiment.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

What is claimed is:

1. A method for synthesizing single phase multi-element metal oxide nanoparticles, said method comprising:
dissolving an organometallic compound precursor of formula M(acac)ₙ for each different element of the multi-element metal oxide, in an organic solvent;
impregnating a support with the organometallic compound precursors;
reducing the organometallic compound precursors to obtain alloy nanoparticles on the support; and
annealing the alloy nanoparticles and the support to remove the support and to convert the alloy nanoparticles to oxide nanoparticles, wherein
M is one or more of a metal selected from ruthenium (Ru), Iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn) or cerium (Ce); and
n is an integer representing the number of acac ligands bound to the respective metal.

2. The method according to claim 1, wherein M is one or more of a metal selected from ruthenium (Ru), cobalt (Co), nickel (Ni), manganese (Mn), chromium (Cr), or titanium (Ti).

3. The method according to claim 1, wherein n is an integer between 2 to 4.

4. The method according to claim 1, wherein the multi-element metal oxide nanoparticles comprise a total of five (5) different metal elements.

5. The method according to claim 1, wherein the single phase is a tetragonal rutile phase.

6. The method according to claim 1, wherein the organic solvent is selected from isopropanol and ethanol.

7. The method according to claim 1, wherein the support is carbon selected from carbon black, ketjenblack, carbon nanotubes (CNTs), graphene, carbon nanofibers, and mesoporous carbon.

8. The method according to claim 1, wherein impregnating a support with the organometallic compound precursors comprises wet impregnation.

9. The method according to claim 1, wherein reducing comprises annealing the organometallic compound precursors at 600-900 °C for 1-5 hours in Ar/7% H₂.

10. A method for synthesizing single phase multi-element doped ruthenium dioxide nanoparticles, said method comprising:

(1) dissolving organometallic compound precursors of formula M(acac)ₙ for each different element of the multi-element doped ruthenium dioxide in an organic solvent, wherein
M comprises metals selected from ruthenium (Ru), iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn) or cerium (Ce); and
n is an integer representing the number of acac ligands bound to the respective metal;

(2) impregnating the organometallic compound precursors on a support;

(3) reducing the organometallic precursors to obtain alloy nanoparticles on the support; and

(4) annealing the alloy nanoparticles and the support to remove the support and to convert the alloy nanoparticles to oxide nanoparticles.

11. The method according to claim 10, wherein M is one or more of a metal selected from ruthenium (Ru), cobalt (Co), nickel (Ni), manganese (Mn), chromium (Cr), or titanium (Ti).

12. The method according to claim 10, wherein n is an integer between 2 to 4.

13. The method according to claim 10, wherein the multi-element doped ruthenium dioxide nanoparticles comprise a total of five (5) different metal elements.

14. The method according to claim 10, wherein the single phase is a tetragonal rutile phase.

15. The method according to claim 10, wherein the organic solvent is selected from isopropanol and ethanol.

16. The method according to claim 10, wherein reducing comprises annealing the organometallic compound precursors at 600-900 °C for 1-5 hours in Ar/7% H₂.

17. The method according to claim 10, wherein the ruthenium dioxide nanoparticles comprise Ru_{0.75}(MnNiTiCo)_{0.25}O₂.

18. The method according to claim 10, wherein the ruthenium dioxide nanoparticles comprise Ru_{0.75}(CrNiMnCo)_{0.25}O₂.

19. A method for synthesizing quaternary-doped ruthenium dioxide of formula Ruₓ(M1M2M3M4)₁₋ₓO₂, said method comprising:
(1) dissolving organometallic compound precursors of each of Ru(acac)₃, M1(acac)ₙ, M2(acac)ₙ, M3(acac)ₙ and M4(acac)ₙ in an organic solvent, wherein
M1, M2, M3, and M4 are each selected from iridium (Ir), iron (Fe), cobalt (Co), nickel (Ni), manganese (Mn), chromium (Cr), copper (Cu), niobium (Nb), tungsten (W), gold (Au), molybdenum (Mo), zinc (Zn), aluminum (Al), magnesium (Mg), titanium (Ti), zirconium (Zr), tin (Sn), or cerium (Ce);
x is in a range of 0.2 to 0.75; and
n is an integer representing the number of acac ligands bound to the respective metal;
(2) impregnating the organometallic compound precursors on a support;
(3) reducing the organometallic compound precursors to obtain alloy nanoparticles on the support; and
(4) annealing the alloy nanoparticles and the support to remove the support and to convert the alloy nanoparticles to oxide nanoparticles.

20. The method according to claim 19, wherein reducing comprises annealing the organometallic compound precursors at 600-900 °C for 1-5 hours in Ar/7% H₂.
